(19) United States
(12) Patent Application Publication
(10) Pub. No.: US 2015/0106492 A1
(43) Pub. Date: Apr. 16, 2015

(54) ELECTRONIC DEVICE, DISPLAY METHOD FOR ELECTRONIC DEVICE, AND COMPUTER-READABLE RECORDING MEDIUM

(71) Applicant: Samsung Electronics Co., Ltd., Suwon-si (KR)

(72) Inventors: Hae-Ree NA, Seoul (KR); Sung-Wang KIM, Seoul (KR); Mi-Yeoung CHUNG, Seoul (KR); Yoon-Jung CHOI, Seongnam-si (KR)

(73) Assignee: Samsung Electronics Co., Ltd., Suwon-si (KR)

(21) Appl. No.: 14/202,532

(22) Filed: Mar. 10, 2014

(30) Foreign Application Priority Data
Oct. 15, 2013 (KR) 10-2013-0122535

(51) Int. Cl. H04L 12/24

(52) U.S. Cl. CPC H04L 41/00
USPC 709/223

(57) ABSTRACT

A display method for an electronic device is provided. The display method includes sending a request for information about at least one other electronic device connected to the electronic device to a management server, receiving a screen image of each of the at least one other electronic device from the management server, and displaying the received screen image.

### CROSS-REFERENCE TO RELATED APPLICATION(S)

This application claims the benefit under 35 U.S.C. §119(a) of a Korean patent application filed on Oct. 15, 2013 in the Korean Intellectual Property Office and assigned Serial number 10-2013-0122535, the entire disclosure of which is hereby incorporated by reference.

### TECHNICAL FIELD

The present disclosure relates to an electronic device, a display method for the electronic device to display information regarding the electronic device, and a computer-readable recording medium. More particularly, the present disclosure relates to an electronic device configured to send, to a management server, a request for information about at least one other electronic device connected thereto, and to receive a screen image of the connected device from the management server, the electronic device including a display unit for displaying the received screen image.

### BACKGROUND

Recently, an increased amount of services and additional functions have been provided in electronic devices. To improve the usefulness of the electronic devices and to meet the various demands of users, a variety of functions executable on the electronic devices have been developed.

Currently, electronic devices may be connected to each other by wireless and/or wired communication means, and data is exchanged between the connected electronic devices such that various network-related functions may be provided.

In such cases, to indicate that at least one electronic device is connected to a particular electronic device, the particular electronic device may display on a screen thereof a model name of the connected electronic device. A user can then read the displayed model name of the electronic device, thus recognizing the connected electronic device.

Nonetheless, it may be difficult to identify an electronic device simply by its model name. For example, if each of a plurality of connected electronic devices uses the same model name, the electronic devices may not be capable of being distinguished from one another.

Therefore, a need exists for an electronic device capable of sending a request for information about at least one other electronic device connected thereto, and to receive and display a screen image of the connected electronic device to a user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device, a display method for the electronic device, and a computer-readable recording medium in which, to display information about at least one other electronic device connected thereto, screen images of the connected at least one other electronic devices are received and displayed, and thus the connected other electronic devices can be distinguished from one another.

Other objects to be provided in the present disclosure may be understood by various embodiments described below.

In accordance with an aspect of the present disclosure, a display method for an electronic device is provided. The display method includes sending a request for information about at least one other electronic device connected to the electronic device to a management server, receiving a screen image of each of the at least one other electronic device from the management server, and displaying the received screen image.

In accordance with another aspect of the present disclosure, an electronic device is provided. The electronic device includes a controller configured to send a request for information about at least one other electronic device connected to the electronic device to a management server, and to receive a screen image of each of the at least one other electronic device from the management server, and a display unit configured to display the received screen image.

Information regarding the display method for the electronic device may be stored on a computer-readable recording medium. The recording medium may include any kind of recording device capable of storing data that is readable by a computer system. Examples of the computer-readable recording medium include read-only memory (ROM), random access memory (RAM), Compact Disk (CD), Digital Video Disk (DVD)-ROM, magnetic tapes, floppy disks, optical data storage devices, embedded Multimedia Cards (eMMC), and the like. The recording medium can also be distributed over network coupled computer systems so that the computer-readable code is stored and executed in a distributed fashion.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram showing a system according to an embodiment of the present disclosure;

FIG. 2 is a diagram showing a system according to an embodiment of the present disclosure;

FIG. 3 is a block diagram showing an electronic device according to an embodiment of the present disclosure;

FIG. 4 is a ladder diagram showing a process of displaying a screen image in a system according to an embodiment of the present disclosure;

FIG. 5 is a flowchart showing a process of transmitting a screen image in a management server according to an embodiment of the present disclosure;

FIG. 6 is a flowchart showing a process of transmitting a changed screen image in a management server according to an embodiment of the present disclosure;

FIG. 7 is a flowchart showing a process of displaying a screen image in an electronic device according to an embodiment of the present disclosure;

FIG. 8 is a flowchart showing a process of transmitting a changed screen image in an electronic device according to an embodiment of the present disclosure;

FIG. 9 is a diagram showing an electronic device displaying screen images according to an embodiment of the present disclosure;

FIG. 10 is a diagram showing an electronic device displaying screen images according to another embodiment of the present disclosure;

FIGS. 11 to 13 are diagrams showing screen images that are displayed to fit into a screen size of an electronic device according to an embodiment of the present disclosure;

FIG. 14 is a block diagram of an electronic device according to an embodiment of the present disclosure; and

FIG. 15 is a perspective view of an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology. As long as the terms are not defined obviously, they are not ideally or excessively analyzed as formal meanings.

According to various embodiments of the present disclosure, a particular electronic device displays screen images of at least one other electronic device associated with the particular electronic device (for example, electronic devices connected to the particular electronic device by a communication, electronic devices registered in a management server that manages a connection among a plurality of electronic devices, or electronic devices connected to the particular electronic device in a group), making it easy to distinguish the other electronic devices from one another.

The screen image may be a screen image currently displayed on each of the electronic devices or may be a particular screen image (for example, a screen image in a standby mode, a home screen image, a wallpaper image, or a user-set image, such as an image stored in a gallery) of each electronic device.

In the following description of various embodiments of the present disclosure, the term “particular electronic device” may in some cases be alternatively referred to as a “requesting electronic device,” or a “particular requesting electronic device,” and vice versa. Likewise, the term “other device” may in some cases alternatively be referred to as a “connected device” or an “associated device,” and vice versa.

According to an embodiment of the present disclosure, if a particular electronic device requests a management server to transmit one or more screen images of at least one electronic device associated with the particular electronic device, the management server provides the screen images collected from the respective electronic devices and transmits them to the requesting electronic device. Thus, the requesting electronic device may display the screen images of the at least one electronic device associated with the requesting electronic device, allowing the at least one electronic device to be distinguished from other devices.

According to another embodiment of the present disclosure, if the screen images of the connected electronic devices are changed, the changed screen images are transmitted to update the screen images of the at least one associated electronic device, and are then capable of being displayed on the particular electronic device.

In the following description of various embodiments of the present disclosure, as mentioned above, the term “screen image” may include a screen image currently displayed on each electronic device or a particular screen image of each electronic device (for example, a screen image in a standby mode, a home screen image, a wallpaper image, a user-set image, such as an image stored in a gallery, or the like).

Also, in the various embodiments of the present disclosure described herein, the particular electronic device may display information about at least one electronic device associated with the particular electronic device on the screen. The term “associated” electronic devices may denote electronic devices connected with the particular electronic device over a network or other electronic devices registered by a user with respect to the particular electronic device.

In the following description of the various embodiments of the present disclosure, the term “electronic device” may include any device having at least one processor, and examples of the electronic device may include a camera, an electronic device, a mobile terminal, a communication terminal, a portable communication terminal, a portable mobile terminal, and so forth. For example, the electronic device may be a digital camera, a smart phone, a cellular phone, a game console, a television (TV), a display device, a vehicle head unit, a laptop computer, a tablet computer, a Personal Media Player (PMP), a Personal Digital Assistant (PDA), a navigation system, an Automatic Teller Machine (ATM) of a bank, a Point of Service (POS) device of a store, or the like. In the various embodiments of the present disclosure, the electronic device may be a flexible device or a flexible display device. In the various embodiments of the present disclosure, the electronic device may also be a wearable device (for example, a watch-type device, a glasses-type device, or a clothing-type device).

Hereinafter, to help those of ordinary skill in the art easily carry out the present disclosure, the various embodiments of the present disclosure will be described with reference to the accompanying drawings.

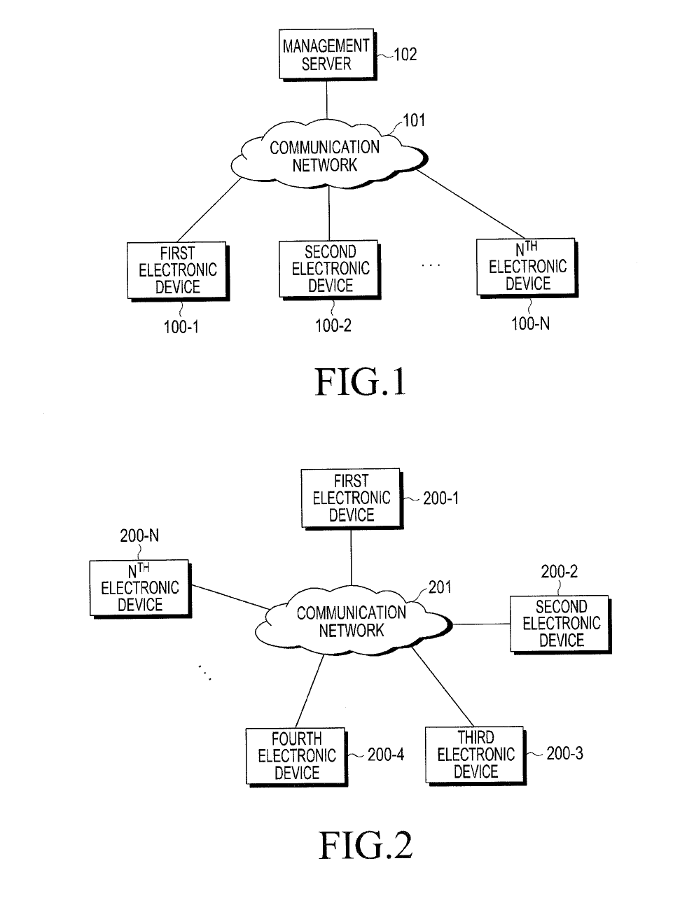

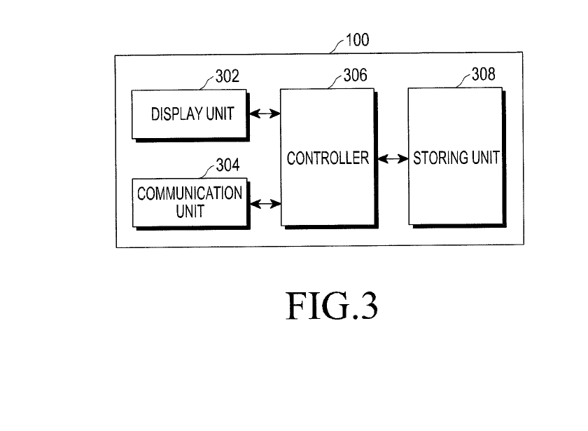

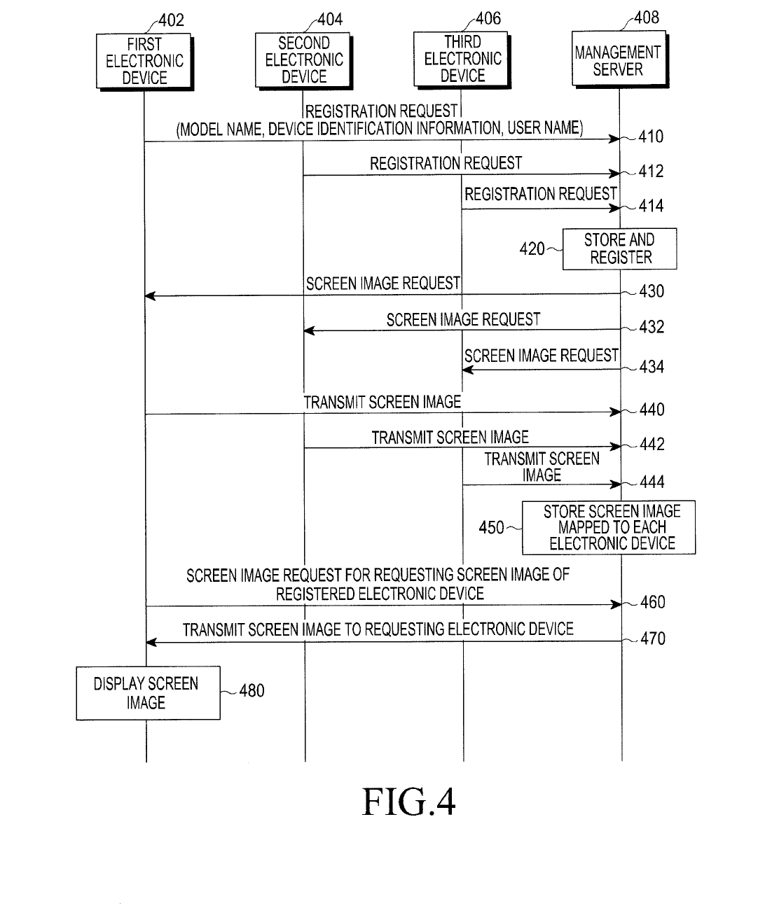

Hereunder, a structure of a system according to an embodiment of the present disclosure will be described with reference to FIGS. 1 and 2, and then a structure of an electronic device according to an embodiment of the present disclosure will be described with reference to FIG. 3.

According to an embodiment of the present disclosure, a user who uses an N-screen service sees information about electronic devices, which are associated with a particular electronic device and which have been registered in a management server, displayed on a screen of the electronic device, thus capable of being distinguished from one another. More particularly, a screen image of each of the associated electronic devices registered in the management server is displayed on a screen of the particular electronic device, such that the user may easily identify each electronic device associated with the particular electronic device.

FIG. 1 is a diagram showing a system according to an embodiment of the present disclosure.

Referring to FIG. 1, the system according the embodiment of the present disclosure may include a communication network 101, a management server 102, and a plurality of electronic devices 100 (for example, a first electronic device 100-1, a second electronic device 100-2, and an N^{th} electronic device 100-N).

The first electronic device 100-1, the second electronic device 100-2, and the N^{th} electronic device 100-N may send registration requests for registration in the management server 102. In embodiments, each of the first electronic device 100-1, the second electronic device 100-2, and the N^{th} electronic device 100-N may transmit information (for example, a model name, device identification information, and a user name of each electronic device) about them to the management server 102.

The first electronic device 100-1, the second electronic device 100-2, and the N^{th} electronic device 100-N may be of the same type, similar types, or different types. For example, the first electronic device 100-1 may be a PC or a tablet device, and the second electronic device 100-2 may be a smartphone. However, the present disclosure is not limited to the aforementioned devices.

Upon receiving the registration requests from the first electronic device 100-1, the second electronic device 100-2, and the N^{th} electronic device 100-N, the management server 102 stores information about each of the first electronic device 100-1, the second electronic device 100-2, and the N^{th} electronic device 100-N, and registers the first electronic device 100-1, the second electronic device 100-2, and the N^{th} electronic device 100-N.

The management server 102 sends a screen image request to at least one registered electronic devices and receives screen images from the at least one registered electronic devices. For example, the received screen image may be a screen image currently displayed on each registered electronic device or a particular screen image (for example, a screen image in a standby mode, a home screen image, a wallpaper image, or a user-set image, such as an image stored in a gallery) of each registered electronic device. The management server 102 maps the received screen images to respective corresponding electronic devices and stores the mapped screen images.

While it has been described above that the management server 102 sends a screen image request to each electronic device 100 and receives the screen image from the electronic device 100, in an embodiment, the electronic device 100 may be configured to transmit the screen image to the management server 102 without being requested to do so by the management server 102. In the foregoing description, each electronic device 100 transmits the screen image after being registered in the management server 102, but the electronic device 100 may also transmit the screen image, together with the information about the electronic device 100, during registration in the management server 102.

Each electronic device 100 may receive screen images of the other electronic devices 100 from the management server 102 and display the received screen images on the screen. For example, the first electronic device 100-1 may receive the screen images of the second electronic device 100-2 and the N^{th} electronic device 100-N and display them on the screen, allowing the second electronic device 100-2 and the N^{th} electronic device 100-N to be distinguished from each other.

The communication network 101 may be configured regardless of a communication type such as a wired type or a wireless type, and may be configured with various communication networks such as a Personal Area Network (PAN), a Local Area Network (LAN), a Metropolitan Area Network (MAN), a Wide Area Network (WAN), and so forth. The communication network 101 may be the known World Wide Web (WWW) and may also employ a wireless transmission technique used in short-range communication, such as Infrared Data Association (IrDA) or Bluetooth®. The communication network 101 may include a cable broadcasting communication network, a terrestrial broadcasting communication network, or a satellite broadcasting communication network to receive a broadcast signal.

FIG. 2 is a diagram showing a system according to an embodiment of the present disclosure.

Referring to FIG. 2, electronic devices communicate with each other without using the management server 102, such that each electronic device 200 displays screen images of the other electronic devices 200. For example, a first electronic device 200-1 may directly receive screen images from at least one other electronic device associated with the first electronic device 200-1 (for example, a second electronic device 200-1 through an N^{th} electronic device 200-N) over a communication network 201 and display the screen images on a screen of the first electronic device 200-1, thus distinguishing the other electronic devices 200 from one another.

More particularly, the system according to an embodiment of the present disclosure may include the communication network 201, the first electronic device 200-1, the second electronic device 200-2, a third electronic device 200-3, and a fourth electronic device 200-4 through the N^{th} electronic device 200-N.

The first electronic device 200-1 transmits information (for example, the model name, the device identification information, and the user name) about the first electronic device 200-1 to the second electronic device 200-2. In an embodiment, the first electronic device 200-1 and the second electronic device 200-2 may communicate with each other through a wired/wireless communication means, and if they are located close to each other, they may communicate with each other through a wired communication means or a short-range wireless communication means.

According to an embodiment of the present disclosure, the second electronic device 200-2 may transmit its screen image to the first electronic device 200-1, and the first electronic device 200-1 displays the received screen image of the second electronic device 200-2 through a display unit, thus identifying the second electronic device 200-2.

As mentioned before, the received screen image may be a screen image currently displayed on each electronic device or a particular screen image (for example, a screen image in a standby mode, a home screen image, a wallpaper image, and a user-set image, such as an image stored in a gallery) of each electronic device.

Likewise, according to an embodiment of the present disclosure, the first electronic device 200-1 may receive screen images of the third electronic device 200-3 and the fourth electronic device 200-4 through the N^{th} electronic device 200-N, and display the received screen images through the display unit, thus distinguishing the third through N^{th} electronic devices 200-3 through 200-N from one another.

The first electronic device 200-1 through the N^{th} electronic device 200-N according to an embodiment of the present disclosure may be of the same type, similar types, or different types. For example, the first electronic device 200-1 may be a PC or a tablet device and the second electronic device 200-2 may be a smartphone.

The communication network 201 may be configured (but not limited to) in the same manner as the communication network 101 shown in FIG. 1.

FIG. 3 is a block diagram showing a structure of an electronic device according to an embodiment of the present disclosure.

Referring to FIG. 3, the electronic device 100 may include a display unit 302, a communication unit 304, a controller 306, and a storing unit 308.

The display unit 302 displays information (for example, but not limited to, the model name, the device identification information, and the user name) about other electronic devices, which is received through the communication unit 304. According to an embodiment of the present disclosure, the display unit 302 also displays screen images of other electronic devices to allow the other electronic devices to be distinguished from one another.

The display unit 302 may also display information (for example, the model name, the device identification information, and the user name) about the electronic device 100.

The communication unit 304 connects the electronic device 100 to other electronic devices through various communication networks such as a PAN, an LAN, a MAN, a WAN, and so forth to transmit and receive data to and from the other electronic devices. The communication unit 304 may also employ a wireless transmission technique used in short-range communication, such as IrDA or Bluetooth®, and may transmit and receive information about the other electronic devices through a cable broadcasting communication network, a terrestrial broadcasting communication network, a satellite broadcasting network, or the like.

The controller 306 controls the display unit 302 to display the information about the other electronic devices received through the communication unit 304. The controller 306 also controls the storing unit 308 to store the received information about the other electronic devices. The controller 306 controls operations of the electronic device 100. The storing unit 308 stores the received information (for example, the model name, the device identification information, the user name, a screen image, and so forth) about the other electronic devices under control of the controller 306.

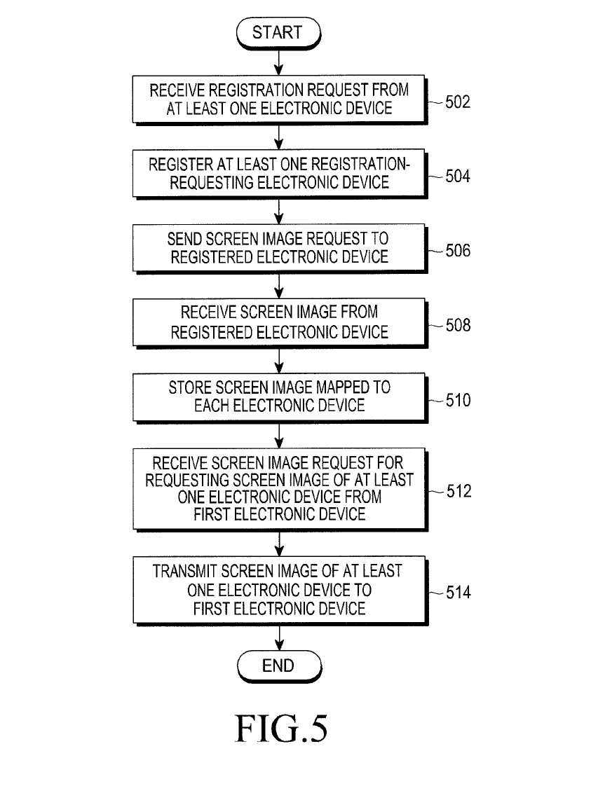

With reference to FIGS. 4 to 8, a description will be made of examples in which an electronic device according to the present disclosure displays a screen image.

FIG. 4 is a ladder diagram showing a process of displaying a screen image in a system according to an embodiment of the present disclosure.

Referring to FIG. 4, while it is described for convenience that a first electronic device 402 receives and displays screen images of a second electronic device 404 and a third electronic device 406, a screen image may be received from one electronic device or two or more electronic devices and displayed and the present disclosure is not limited to the number of connected electronic devices.

In FIG. 4, the first electronic device 402 sends a registration request to a management server 408 in step 410. The first electronic device 402 may transmit information about the first electronic device 402 to the management server 408. For example, to request registration, information, for example, a model name, device identification information, and a user name, may be transmitted, and the information is not limited to these examples.

Like the first electronic device 402, the second electronic device 404 and the third electronic device 406 send registration requests to the management server 408 in steps 412 and 414. The second electronic device 404 and the third electronic device 406 may also transmit information about them to the management server 408.

Upon receiving the registration requests from at least one electronic device (for example, the first electronic device 402, the second electronic device 404, and the third electronic device 406), the management server 408 stores the received information about the at least one electronic device and registers the at least one requesting electronic device in step 420.

As the at least one electronic device is registered in the management server 408, the management server 408 sends screen image requests to the at least one registered electronic device in steps 430, 432, and 434, and receives screen images from the at least one registered electronic device. The screen image may be a screen image currently displayed on each electronic device, or may be a particular screen image (for example, a screen image in a standby mode, a home screen image, a wall paper image, or a user-set image, such as an image stored in a gallery) of each electronic device.

Upon receiving the screen image requests from the management server 408, the at least one electronic device registered in the management server 408 transmits a screen image to the management server 408 in steps 440, 442, and 444.

Thereafter, the management server 408 maps the received screen images to the corresponding electronic device and stores the mapped screen images in step 450.

While it has been described in FIG. 4 that the management server 408 sends the screen image requests to the electronic devices 402, 404, and 406, respectively, and receives the screen images from the electronic devices 402, 404, and 406, the electronic devices 402, 404, and 406 may be configured to transmit their screen images without being requested to do so by the management server 408. Also, it has been described that the electronic devices 402, 404, and 406 transmit their screen images after being registered in the management server 408, but the electronic devices 402, 404, and 406 may be configured to transmit their screen images together with the information about the electronic devices 402, 404, and 406, during registration in the management server 408.

Hence, each of the electronic devices 402, 404, and 406 receives the screen images of the other electronic devices 402, 404, and 406 from the management server 408 and displays the received screen images on the screen. For example, the first electronic device 402 may receive screen images of the second electronic device 404 and the third electronic device 406 and display the received screen images on the screen, such that the first electronic device 402 may distinguish the second electronic device 404 and the third electronic device 406 associated thereto from each other on the screen.

When the first electronic device 402 displays information about other electronic devices (for example, the second electronic device 404 and the third electronic device 406) on its screen, the first electronic device 402 sends a screen image request for requesting a screen image of each of the other electronic devices (for example, the second electronic device 404 and the third electronic device 406) to the management server 408 in step 460.

Upon receiving the screen image request, the management server 408 transmits a screen image mapped to each electronic device to the requesting first electronic device 402 in step 470. According to an embodiment of the present disclosure, the management server 408 may also transmit information about each electronic device, such as a model name, device identification information, and a username of the electronic device, together with the screen image.

Thus, according to an embodiment of the present disclosure, the first electronic device 402 displays the received information about each electronic device and the received screen image of the electronic device in step 480, thus distinguishing the at least one associated electronic devices (for example, the second electronic device 404 and the third electronic device 406) from one another.

According to various embodiments of the present disclosure, the electronic device may process a screen image in various ways described below before displaying the screen image.

For example, the first electronic device 402 may directly resize a received screen image of another electronic device (for example, by adjusting a horizontal, vertical, diagonal, or round length of the screen image) and display the resized screen image on the screen. In another embodiment, the first electronic device 402 may receive a resized screen image of each electronic device from the management server 408 and display the received resized screen image on the screen. In still another embodiment, the first electronic device 402 may receive a resized screen image from another electronic device (for example, the second electronic device 404 or the third electronic device 406) through the management server 408 and display the received resized screen image on the screen.

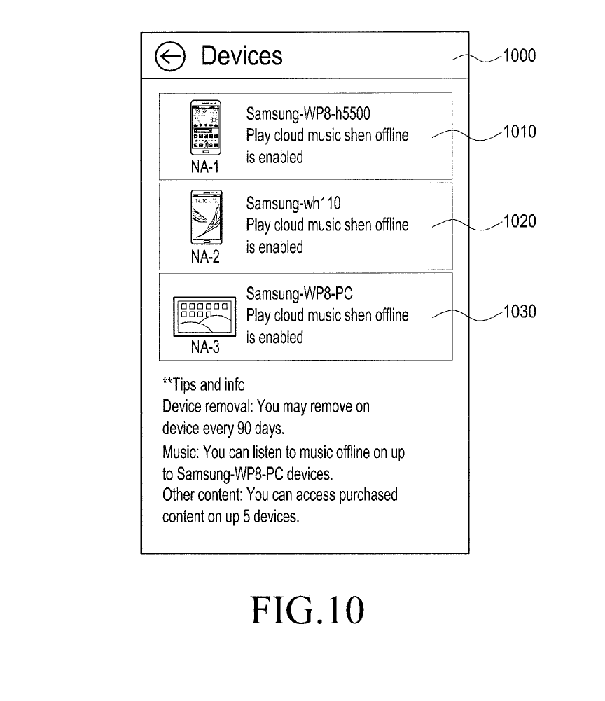

In addition, according to various embodiments of the present disclosure, the electronic device arranges the received screen images in various ways (for example, as shown in FIGS. 9 to 13), allowing the user to easily identify each electronic device.

According to various embodiments of the present disclosure, the electronic device may display information about other electronic devices variously on the screen. For example, the electronic device may display screen images of the other electronic devices alone, or synthesize a frame image of each electronic device corresponding to a model name of the electronic device with the received screen image of the electronic device and display the synthesized image. According to various embodiments of the present disclosure, the electronic device may also display information (for example, the model name, the device identification information, and the user name) about each electronic device, together with the received screen image of the electronic device.

In this way, according to an embodiment of the present disclosure, upon receiving a request for information about at least one electronic device and a screen image request from the first electronic device 402, the management server 408 transmits the information about the at least one electronic device and the screen images of the at least one electronic device to the first electronic device 402, such that the first electronic device 402 may display the information about the at least one electronic device associated with the first electronic device 402 and the screen images of the at least one associated electronic devices.

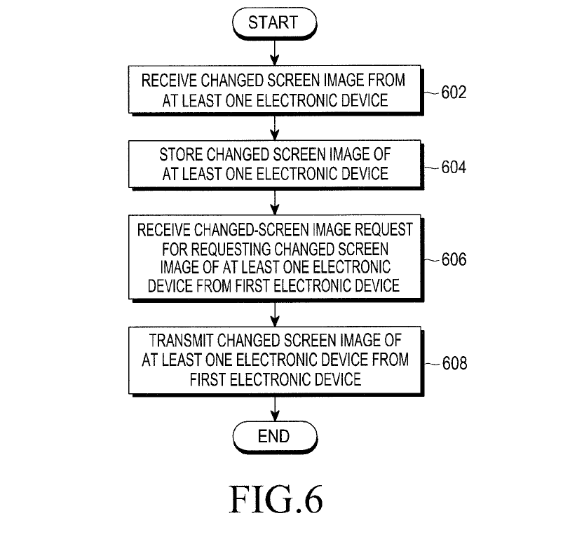

FIG. 5 is a flowchart showing a process of transmitting a screen image in a management server according to an embodiment of the present disclosure.

Referring to FIG. 5, the management server receives registration requests from at least one electronic device in step 502. At this time, the management server may also receive information (for example, the model name, the device identification information, and the user name) about the at least one electronic device.

Upon receiving the registration requests, the management server registers the at least one registration-requesting electronic device in step 504, and may store the information received from each of the at least one electronic device.

The management server sends a screen image request to each of the at least one registered electronic device in step 506, and receives a screen image from each registered electronic device in response to the screen image request in step 508. The screen image may be a screen image currently displayed on each electronic device, or may be a particular screen image (for example, a screen image in a standby mode, a home screen image, a wallpaper image, or a user-set image, such as an image stored in a gallery) of each electronic device. The management server then stores the received screen image mapped to each corresponding electronic device in step 510.

Upon receiving a screen image request for requesting screen images of the at least one electronic device, for example, a screen image of a second electronic device, from a first electronic device in step 512, the management server transmits the screen image of the second electronic device to the first electronic device in step 514. At this time, the management server may also transmit information (for example, the model name, the device identification information, and the user name) about the second electronic device, together with the screen image of the second electronic device.

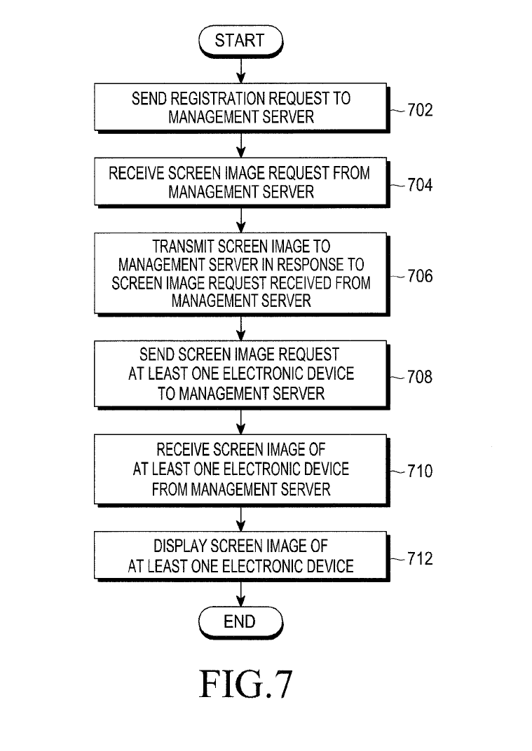

FIG. 6 is a flowchart showing a process of transmitting a changed screen image in a management server according to an embodiment of the present disclosure.

Referring to FIG. 6, the management server may receive a screen image that is changed from a screen image currently stored with respect to a particular electronic device registered in FIG. 5 in step 602. Upon receiving a changed screen image from the particular electronic device in step 602, the management server stores the received changed screen image in step 604.

The management server receives a changed-screen image request for requesting the changed screen images of the at least one electronic device from the first electronic device in step 606. According to another embodiment of the present disclosure, the management server may be configured to transmit the changed screen images to the first electronic device upon receiving the changed screen images without receiving the changed-screen image request from the first electronic device.

Thus, the management server transmits the changed screen images of the at least one electronic device to the first electronic device in step 608. At this time, the management server may also transmit model names, device identification information, and user names of the second electronic device, together with the changed screen images.

As such, according to an embodiment of the present disclosure, when a screen image is changed in an electronic device, the changed screen image is transmitted to each connected electronic device, such that the changed screen image is displayed on each electronic device.

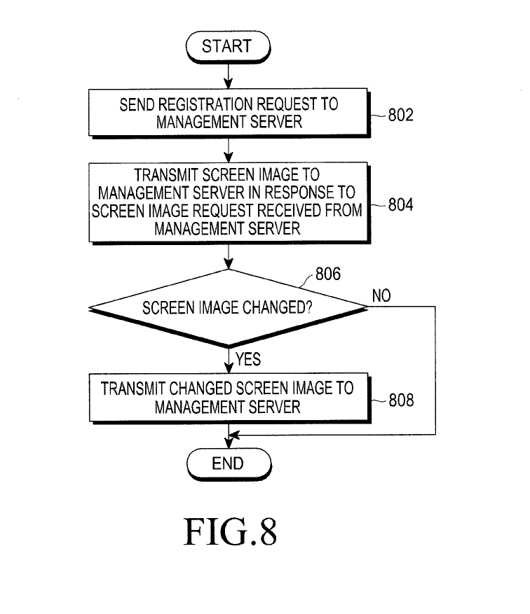

FIG. 7 is a flowchart showing a process of displaying a screen image in an electronic device according to an embodiment of the present disclosure.

Referring to FIG. 7, the electronic device sends a registration request to the management server in step 702. The electronic device may transmit information about itself to the management server. For example, the information may be, but not limited to, a model name, device identification information, or a user name.

The electronic device receives a screen image request from the management server in step 704. The electronic device transmits a screen image in response to the screen image request received from the management server in step 706. The screen image may be a screen image currently displayed on each electronic device, or may be a particular screen image (for example, a screen image in a standby mode, a home screen image, a wallpaper image, or a user-set image, such as an image stored in a gallery) of each electronic device.

To display information about other electronic devices on the screen of the electronic device, the electronic device sends a request for an image of at least one electronic device registered in the management server to the management server in step 708. For example, according to an embodiment of the present disclosure, the information about the at least one electronic device and the screen images may be transmitted.

The electronic device receives the image of the at least one electronic device from the management server in response to the request in step 710 and displays the screen images of the at least one electronic device in step 712.

As such, according to an embodiment of the present disclosure, as the screen images of the at least one electronic device associated with the electronic device are received, the at least one electronic device associated with the electronic device (for example, connected to the electronic device via a network) may be easily distinguished from other associated electronic devices.

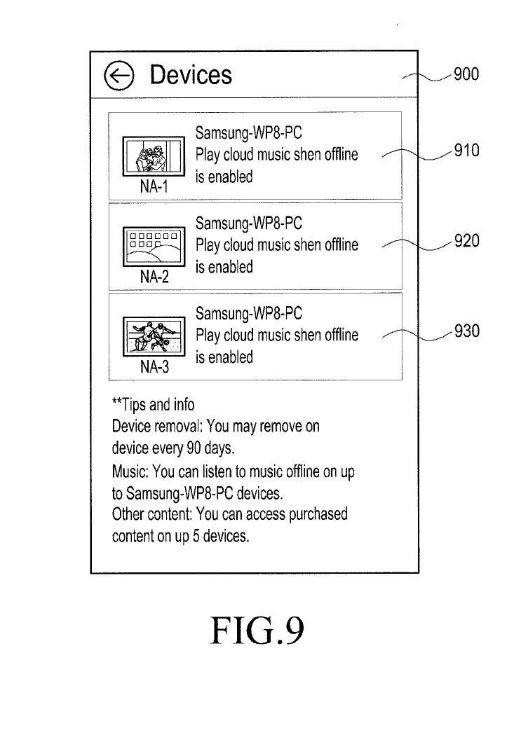

FIG. 8 is a flowchart showing a process of transmitting a changed screen image in an electronic device according to an embodiment of the present disclosure.

Referring to FIG. 8, the electronic device sends a registration request to the management server in step 802. At this time, the electronic device may transmit information about itself to the management server. For example, the information may be, but not limited to, a model name, device identification information, or a user name.

The electronic device may receive a screen image request from the management server. The electronic device transmits a screen image to the management server in response to the screen image request received from the management server in step 804. The screen image may be a screen image currently displayed on each electronic device, or may be a particular screen image (for example, a screen image in a standby mode, a home screen image, a wallpaper image, or a user-set image, such as an image stored in a gallery) of each electronic device.

If the screen image of the electronic device is changed in step 806, the electronic device transmits the changed screen image to the management server in step 808. Thus, each electronic device may update the screen image of the associated electronic device with the changed screen image currently displayed on the associated electronic device, and display the changed screen image on its screen.

Hereinafter, with reference to FIGS. 9 to 13, a description will be made of examples for displaying a screen image of an electronic device according to various embodiments of the present disclosure. In the following examples, each display screen displays information about at least one other electronic device associated with the electronic device. The various embodiments of the present disclosure may be applied to, for example, a screen for managing or displaying other electronic devices connected to the electronic device.

FIG. 9 is a diagram showing an electronic device displaying screen images according to an embodiment of the present disclosure.

Referring to FIG. 9, an electronic device 900 displays a first screen image 910, a second screen image 920, and a third screen image 930. For example, the first screen image 910, which is a screen image of an electronic device NA-1, may be a screen image showing a family photo, the second screen image 920, which is a screen image of an electronic device NA-2, may be a wallpaper image, and the third screen image 930, which is a screen image of an electronic device NA-3, may be a sports broadcast screen image.

On the electronic device 900, a model name indicating a type of each electronic device (for example, a model name of the electronic device NA-1, Samsung-WPB-PC, a model name of the electronic device NA-2, Samsung-WPB-PC, and a model name of the electronic device NA-3, Samsung-WPB-PC) may also be displayed.

As such, according to an embodiment of the present disclosure, even if electronic devices of the same model are displayed on a screen, the user may easily distinguish the electronic devices from each other based on a screen image of each electronic device displayed on the screen.

Meanwhile, according to various embodiments of the present disclosure, the screen images displayed on the electronic device 900 may be resized as described above with reference to FIG. 4.

Also, the electronic device according to various embodiments of the present disclosure may variously arrange the screen images as described with reference to FIG. 4 and variously display information about other electronic devices on the screen. For example, the screen image of each electronic device may be displayed alone, or the received screen image may be synthesized with a device frame corresponding to a model of each electronic device and the synthesized image may be displayed. Information (for example, the model name, the device identification information, and the user name) about each electronic device may also be displayed.

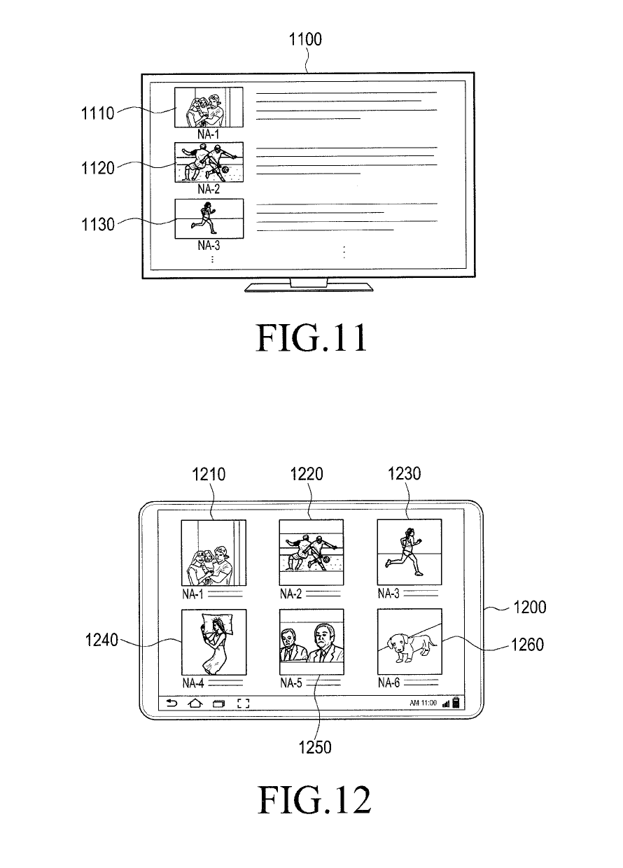

FIG. 10 is a diagram showing an electronic device displaying screen images according to another embodiment of the present disclosure.

Referring to FIG. 10, an electronic device 1000 displays a first screen image 1010 synthesized with a device frame of the electronic device NA-1, a second screen image 1020 synthesized with a device frame of the electronic device NA-2, and a third screen image 1030 synthesized with a device frame of the electronic device NA-3.

On the electronic device 1000, a model name indicating a type of each electronic device (for example, a model name of the first electronic device NA-1, Samsung-WP8-h5500, a model name of the second electronic device NA-2, Samsung-wh110, and a model name of the third electronic device NA-3, Samsung-WPB-PC) may also be displayed.

As such, according to various embodiments of the present disclosure, an electronic device may be more easily identified based on a frame corresponding to a model of the electronic device and a screen image.

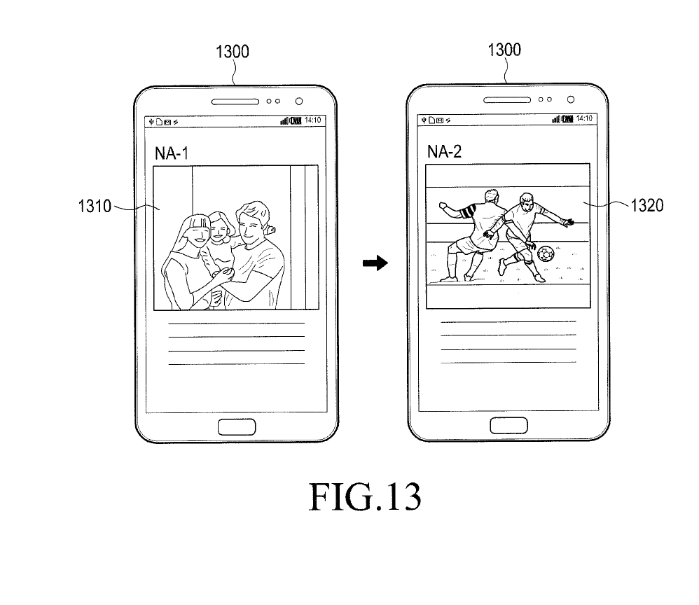

FIGS. 11 to 13 are diagrams showing screen images that are displayed to fit into a screen size of an electronic device according to an embodiment of the present disclosure.

Referring to FIG. 11, an electronic device 1100 (for example, a PC) receives and displays screen images 1110, 1120, and 1130 of electronic devices.

For example, if the electronic device 1100 is a PC, it may have larger display units than those of other electronic devices (for example, a tablet device and a cellular phone). Thus, the multiple screen images 1110, 1120, and 1130 may be displayed as large images on a screen of the PC, and at the same time, information corresponding to each electronic device may be variously displayed.

Referring to FIG. 12, an electronic device 1200 (for example, a tablet device) displays screen images 1210, 1220, 1230, 1240, 1250, and 1260 of electronic devices.

For example, if the electronic device 1200 is a tablet device, it may have a smaller display unit than a PC. Thus, the electronic device 1200 may display the multiple screen images 1210, 1220, 1230, 1240, 1250, and 1260, and at the same time, may display partial information corresponding to each electronic device.

Referring to FIG. 13, an electronic device 1300 (for example, a cellular phone) displays a screen image 1310 of a corresponding electronic device.

For example, if the electronic device 1300 is a smartphone, it may have a smaller display unit than those of other electronic devices (for example, a PC and a tablet device), such that the electronic device 1300 may display the screen image 1310 of one electronic device alone as shown in FIG. 13.

The user of the electronic device 1300 may switch over the screen image 1310 to a screen image 1320 of another electronic device by pressing a particular button or making a preset gesture, and see the switched screen image 1320.

According to an embodiment of the present disclosure, in FIGS. 11 to 13, the screen size of an electronic device has been described based on a size of a PC, a tablet device, or a cellular phone, but the present disclosure is not limited to these examples and various devices may be used and the screen size of each electronic device may be variously provided. For example, the screen size of the cellular phone may be larger than that of the tablet device and/or the PC.

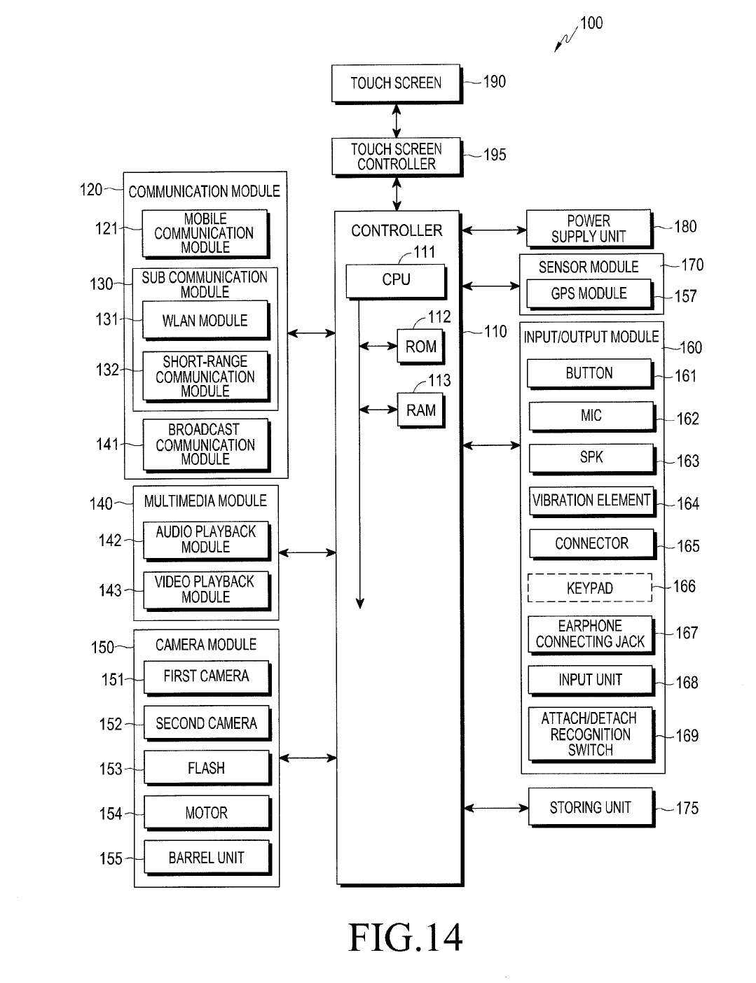

FIG. 14 is a block diagram of an electronic device according to an embodiment of the present disclosure.

Referring to FIG. 14, the electronic device 100 may be connected with an external electronic device (not illustrated) by using at least one of a communication module 120, a connector 165, and an earphone connecting jack 167. The electronic device may include one of various devices which are removable from the electronic device 100 and are connectable with the electronic device 100 in a wired manner, such as, for example, an earphone, an external speaker, a Universal Serial Bus (USB) memory, a charging device, a cradle/dock, a Digital Multimedia Broadcasting (DMB) antenna, a mobile payment-related device, a health management device (a blood pressure monitor or the like), a game console, a vehicle navigation device, and so forth. The electronic device may include a wirelessly connectible Bluetooth communication device, a Near Field Communication (NFC) device, a WiFi Direct communication device, and a wireless Access Point (AP). The electronic device 100 may be connected with another portable terminal or electronic device such as, for example, one of a cellular phone, a smart phone, a tablet Personal Computer (PC), a desktop PC, and a server, in a wired or wireless manner.

The electronic device 100 may include at least one touch screen 190 and at least one touch screen controller 195. The electronic device 100 may also include a controller 110, the communication module 120, a multimedia module 140, a camera module 150, an input/output module 160, a sensor module 170, a storing unit 175, and a power supply unit 180. The communication module 120 may include a mobile communication module 121, a sub communication module 130, and a broadcast communication module 141. The sub communication module 130 may include at least one of a Wireless Local Area Network (WLAN) module 131 and a short-range communication module 132. The multimedia module 140 may include at least one of an audio playback module 142 and a video playback module 143. The camera module 150 may include at least one of a first camera 151 and a second camera 152. The input/output module 160 may include at least one of a button 161, a microphone 162, a speaker 163, a vibration element 164, a connector 165, and a keypad 166.

The controller 110 may include a Central Processing Unit (CPU) 111, a Read Only Memory (ROM) 112 in which a control program for controlling the electronic device 100 is stored, and a Random Access Memory (RAM) 113 which memorizes a signal or data input from the electronic device 100 or is used as a memory region for a task performed in the electronic device 100. The CPU 111 may include a single core, a dual core, a triple core, or a quad core processor. The CPU 111, the ROM 112, and the RAM 113 may be interconnected through an internal bus.

The controller 110 may also control at least one of the communication module 120, the multimedia module 140, the camera module 150, the input/output module 160, the sensor module 170, the storing unit 175, the power supply unit 180, the touch screen 190, and the touch screen controller 195.

The controller 110 senses a user input event such as approaching of the input unit 168 to the touch screen 190 or a hovering event occurring when the input unit 168 is disposed in proximity to the touch screen 190. The controller 110 detects various user inputs received through the camera module 150, the input/output module 160, and the sensor module 170 as well as the touch screen 190. The user input may include various types of information input to the electronic device 100, such as not only the touch, but also a gesture, voice, eye movement, iris recognition, and a biomedical signal of a user. The controller 110 controls a predetermined step or function corresponding to the detected user input to be performed in the electronic device 100.

The controller 110 outputs a control signal to the input unit 168 or the vibration element 164. The control signal may include information about a vibration pattern, and the input unit 168 or the vibration element 164 generates a vibration corresponding to the vibration pattern. The information about the vibration pattern may indicate the vibration pattern or an identifier corresponding to the vibration pattern. The control signal may include a vibration generation request alone.

The electronic device 100, depending on its capability, may include at least one of the mobile communication module 121, the WLAN module 131, and the short-range communication module 132.

The mobile communication module 121 may facilitate the connection between the electronic device 100 and an external device through mobile communication by using one or more antennas (not illustrated) under control of the controller 110. The mobile communication module 121 transmits/receives a wireless signal for a voice call, a video call, a text message (e.g., Short Messaging Service (SMS)), and/or a multimedia message (e.g., Multimedia Messaging Service (MMS)) with a cellular phone (not illustrated), a smart phone (not illustrated), a tablet PC, or a second electronic device (not illustrated) which has a phone number input into the electronic device 100.

The sub communication module 130 may include at least one of the WLAN module 131 and the short-range communication module 132. Alternatively, the sub communication module 130 may include either the WLAN module 131 or the short-range communication module 132, or both.

The WLAN module 131 may be connected to the Internet in a place where a wireless AP (not illustrated) is installed, under control of the controller 110. The WLAN module 131 supports the wireless LAN standard IEEE802.11x of the Institute of Electrical and Electronics Engineers (IEEE). The short-range communication module 132 may wirelessly perform short-range communication between the electronic device 100 and an external electronic device under control of the controller 110. The short-range communication may include Bluetooth, Infrared Data Association (IrDA), WiFi-Direct communication, NFC communication, or the like.

The broadcast communication module 141 receives a broadcast signal (for example, a TV broadcast signal, a radio broadcast signal, or a data broadcast signal) and broadcast additional information (for example, Electric Program Guide (EPG) or Electric Service Guide (ESG)) transmitted from a broadcasting station (not shown) via a broadcast communication antenna (not illustrated) under control of the controller 110.

The multimedia module 140 may include the audio playback module 142 or the video playback module 143. The audio playback module 142 may play a digital audio file (for example, a file having a file extension such as ‘mp3’, ‘wma’, ‘ogg’, or ‘way’) stored in the storing unit 175 or received under control of the controller 110. The video playback module 143 may play a digital video file (for example, a file having a file extension such as ‘mpeg’, ‘mpg’, ‘mp4’, ‘avi’, ‘mov’, or ‘mkv’) stored or received under control of the controller 110. The multimedia module 140 may be integrated into the controller 110.

The multimedia module 140 may be integrated into the controller 110. The camera module 150 may include at least one of the first camera 151 and the second camera 152 which capture a still image or a video under control of the controller 110. The camera module 150 may also include at least one of the barrel unit 155 for performing the zoom-in/zoom-out operations for photographing, the motor 154 for controlling motion of the barrel unit 155, and the flash 153 for providing an auxiliary light source necessary for photographing. The first camera 151 may be positioned on the front surface of the terminal 100, and the second camera 152 may be positioned on the rear surface of the terminal 100.

The input/output module 160 includes the at least one button 161, the at least one microphone 162, the at least one speaker 163, the at least one vibration element 164, the connector 165, the keypad 166, the earphone connecting jack 167, and the input unit 168. However, it should be noted that the input/output module 160 is not limited to those examples, and a cursor control such as, for example, a mouse, a track ball, a joy stick, or a cursor direction key may be provided to control movement of a cursor on the touch screen 190.

The button 161 may be formed on at least one of a front surface, a side surface, and a rear surface of a housing (or case) of the electronic device 100, and may include at least one of a power/lock button, a volume button, a menu button, a home button, a back button, and a search button.

The microphone 162 receives voice or sound and generates a corresponding electric signal under control of the controller 110. The speaker 163 outputs sound corresponding to various signals or data (for example, wireless data, broadcast data, digital audio data, digital video data, or the like) under control of the controller 110. The speaker 163 may output sound corresponding to a function executed by the terminal 100 (for example, button manipulation sound corresponding to a phone call, a ring back tone, or voice of a counterpart user). One or more speakers 163 may be formed in a proper position or proper positions of the housing of the electronic device 100.

The vibration element 164 converts an electric signal into mechanical vibration under control of the controller 110. For example, in the electronic device 100, in a vibration mode, if a voice call or a video call from another device (not illustrated) is received, the vibration element 164 operates. One or more of the vibration element 164 may be disposed in the housing of the electronic device 100. The vibration element 164 may operate in response to user input generated through the touch screen 190.

The connector 165 may be used as an interface for connecting the electronic device 100 with an external device (not illustrated) or a power source (not illustrated). Under control of the controller 110, data stored in the storing unit 175 of the electronic device 100 may be transmitted to an external electronic device or data may be received from the external electronic device through a wired cable connected to the connector 165. The electronic device 100 receives power from the power source through the wired cable connected to the connector 165 or may charge a battery (not illustrated) by using the power source.

The keypad 166 receives key input from the user for control of the electronic device 100. The keypad 166 includes a physical keypad (not illustrated) formed in the electronic device 100 or a virtual keypad (not illustrated) displayed on the touch screen 190. The physical keypad (not illustrated) formed in the electronic device 100 may be excluded according to the capability or structure of the electronic device 100. An earphone (not illustrated) may be inserted into the earphone connecting jack 167 to be connected to the electronic device 100.

The input unit 168 may be inserted into the electronic device 100 for keeping, and when being used, may be withdrawn or separated from the electronic device 100. In a region of an inner side of the electronic device 100 into which the input unit 168 is inserted, an attach/detach recognition switch 169 is disposed to provide a signal corresponding to attachment or detachment of the input unit 168 to the controller 110. The attach/detach recognition switch 169 may be configured to directly or indirectly contact the input unit 168 when the input unit 168 is mounted. Thus, the attach/detach recognition switch 169 generates the signal corresponding to attachment or separation of the input unit 168 (that is, a signal for indicating the attachment or detachment of the input unit 168) based on whether it contacts the input unit 168, and outputs the signal to the controller 110.

The sensor module 170 includes at least one sensor for detecting a state of the terminal 100. For example, the sensor module 170 may include at least one of a proximity sensor for detecting the user's proximity with respect to the terminal 100, an illumination sensor (not illustrated) for detecting an amount of light around the terminal 100, a motion sensor (not illustrated) for detecting an operation of the terminal 100 (for example, rotation of the terminal 100 or acceleration or vibration applied to the terminal 100), a geo-magnetic sensor (not illustrated) for detecting a point of the compass by using the Earth's magnetic field, a gravity sensor for detecting a working direction of the gravity, an altimeter for measuring an atmospheric pressure to detect an altitude, and a Global Positioning System (GPS) module 157.

The GPS module 157 receives electric waves from a plurality of GPS satellites (not illustrated) in the Earth's orbit, and calculates a location of the terminal 100 by using a time of arrival from the GPS satellite (not illustrated) to the terminal 100.

The storing unit 175 stores a signal or data which is input/output corresponding to operations of the communication module 120, the multimedia module 140, the camera module 150, the input/output module 160, the sensor module 170, or the touch screen 190, under control of the controller 110. The storing unit 175 may also store a control program and applications for control of the terminal 100 and/or the controller 110.

The term “storing unit” includes the storing unit 175, the ROM 112 and the RAM 113 in the controller 110, or a memory card (not illustrated) mounted in the terminal 100 (for example, a Secure Digital (SD) card, a memory stick). The storing unit 175 may include a non-volatile memory, a volatile memory, a Hard Disk Drive (HDD), or a Solid State Drive (SSD).

The storing unit 175 may also store applications of various functions such as a real-time communication application, navigation, video communication, games, an alarm application based on time, images for providing a Graphic User Interface (GUI) related to the applications, user information, documents, databases or data related to a method for processing touch inputs, background images (for example, a menu screen, a standby screen, and so forth), operation programs necessary for driving the electronic device 100, and images captured by the camera module 150.

The storing unit 175 is a machine, such as, for example, a non-transitory computer-readable medium. The term “machine-readable medium” includes a medium for providing data to the machine to allow the machine to execute a particular function. The storing unit 175 may include non-volatile media or volatile media. Such a medium needs to be of a tangible type so that commands delivered to the medium can be detected by a physical tool which reads the commands with the machine.

The machine-readable medium may include, but is not limited to, at least one of a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), a flash EPROM, and an embedded Multi Media Card (eMMC).

The power supply unit 180 supplies power to one or more batteries disposed in the housing of the electronic device 100 under control of the controller 110. The one or more batteries supply power to the electronic device 100. The power supply unit 180 may also supply power input from an external power source through the wired cable connected with the connector 165 to the electronic device 100. The power supply unit 180 may also supply power, which is wirelessly input from an external power source using a wireless charging technique, to the electronic device 100.

The electronic device 100 may include the at least one touch screen 190 which provides a user graphic interface corresponding to various services (for example, call, data transmission, broadcasting, picture taking) to users. The touch screen 190 outputs an analog signal, which corresponds to at least one input to the user graphic interface, to the touch screen controller 195.

The touch screen 190 receives at least one user inputs through a user's body (for example, a finger including a thumb) or the input unit 168 (for example, a stylus pen or an electronic pen). The touch screen 190 may be implemented as, for example, a resistive type, a capacitive type, an infrared type, an acoustic wave type, or a combination thereof.

The touch screen 190 may include at least two touch panels capable of sensing a touch, an approach of a finger, or the input unit 168 to receive inputs generated by the finger or the input unit 168. The at least two touch panels provide different output values to the touch screen controller 195. Thus, the touch screen controller 195 differently recognizes the values input from the at least two touch screen panels to identify whether the input from the touch screen 190 is the input generated by the finger or by the input unit 168.

The touch may also include a non-contact touch (for example, when a detectable interval or distance between the touch screen 190 and the user's body or touch input means is less than 1 mm) as well as a direct touch between the touch screen 190 and the user's body or touch input means. The detectable interval or distance from the touch screen 190 may be changed according to the capability or structure of the electronic device 100.

The touch screen controller 195 converts the analog signal received from the touch screen 190 into a digital signal and transmits the digital signal to the controller 110. The controller 110 controls the touch screen 190 by using the digital signal received from the touch screen controller 195. For example, the controller 110 may control a shortcut icon (not illustrated) displayed on the touch screen 190 to be selected or executed in response to a direct touch event or a hovering event. The touch screen controller 195 may be included in the controller 110. The touch screen controller 195, by detecting a value (for example, an electric-current value) output through the touch screen 190, recognizes a hovering interval or distance as well as a user input position and converts the recognized distance into a digital signal (for example, a Z coordinate), which it then sends to the controller 110. The touch screen controller 195 may also, by detecting the value (for example, an electric-current value) output through the touch screen 190, detect a pressure applied by the user input means to the touch screen 190, convert the detected pressure into a digital signal, and provide the digital signal to the controller 110.

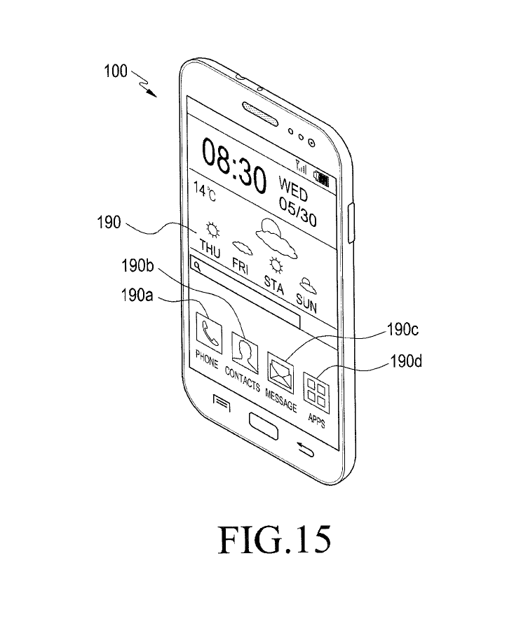

FIG. 15 is a perspective view of an electronic device according to an embodiment of the present disclosure.

Referring to FIG. 15, the electronic device 100 may be, but not limited to, a PC, a tablet device, and a cellular phone, and may be configured with various devices.

In FIG. 15, a touch screen is disposed in the center of a front surface of the electronic device 100. The touch screen 190 may be large enough to occupy most of the front surface of the electronic device 100.

Different home screens of several pages may be displayed on the screen of the electronic device 100, and a main home screen may be the first home screen among the home screens of the several pages as shown in FIG. 15. Shortcut icons 190a, 190b, and 190c for executing frequently used applications, a main menu change key 190d, time, weather, and so forth may be displayed on the home screen. The main menu change key 190d is used to display a menu screen on the touch screen 190. A status bar indicating a state of the electronic device 100, such as a battery charge state, a strength of a received signal, and a current time, may be formed in an upper portion of the touch screen 190.

The display method for the electronic device according to the embodiment of the present disclosure may be implemented as a program command, which can be executed by various computer means, and may be recorded on a computer-readable medium. The computer-readable medium may include a program command, a data file, and a data structure alone or in combination. The program command recorded on the medium may be specially designed and configured for the present disclosure, or may be well known and available to those of ordinary skill in the computer software field.

Also, display methods according to the embodiment of the present disclosure may be implemented as a program command and stored in the storing unit 175 of the electronic device 100. The program command may be temporarily stored in the RAM 113 of the controller 110 for execution of the display methods according to the embodiment of the present disclosure. Thus, the controller 110 controls hardware components included in the electronic device 100 in response to the program command corresponding to the display methods according to the embodiment of the present disclosure, temporarily or continuously stores data generated during execution of the display methods in the storing unit 175, and provides a UI required for execution of the display methods to the touch screen controller 195.

In the foregoing description, specific examples of configurations and components are merely provided to assist in the overall understanding of the various embodiments of the present disclosure and it will be apparent to those skilled in the art that the present disclosure is not limited to these examples and various modifications and changes may be possible from the various embodiments.

Therefore, the spirit of the present disclosure should not be defined by the disclosed embodiment and the spirit of the present disclosure may be understood by the following claims, and equal or equivalent modifications thereof fall within the scope of the spirit of the present disclosure.

According to an embodiment of the present disclosure, on a screen of an electronic device, screen images (for example, wallpaper images) displayed on other electronic devices connected to the electronic device are displayed, such that the user may conveniently distinguish the connected electronic devices based on the information displayed on the screen.

Moreover, according to an embodiment of the present disclosure, if other electronic devices are connected or registered on a management screen of an electronic device, screen images of the connected or registered electronic devices are displayed, such that the user may intuitively identify each electronic device.

The other effects may be explicitly or implicitly disclosed in the description of the present disclosure.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display method for an electronic device, the display method comprising:
sending a request for information about at least one other electronic device connected to the electronic device to a management server;
receiving a screen image of each of the at least one other electronic device from the management server; and
displaying the received screen image.

2. The display method of claim 1, wherein the screen image comprises a screen image currently displayed on each electronic device.

3. The display method of claim 1, wherein the screen image one or more of a screen image in a standby mode, a home screen image, a wallpaper image, and a user-set image in each electronic device.

4. The display method of claim 1, further comprising:
receiving a model image of each electronic device; and
displaying the image.

5. The display method of claim 4, further comprising synthesizing the received model image with the received screen image of each electronic device and displaying the synthesized image.

6. The display method of claim 1, further comprising:
receiving information about each other electronic device; and
displaying the received information together with the received screen image of each other electronic device.

7. The display method of claim 6, wherein the information about each electronic device comprises one or more of a model name, device identification information, and a user name of the electronic device.

8. The display method of claim 1, further comprising:
resizing the received screen image; and
displaying the resized screen image.

9. An electronic device comprising:
a controller configured to send a request for information about at least one other electronic device connected to the electronic device to a management server, and to receive a screen image of each of the at least one other electronic device from the management server; and
a display unit configured to display the received screen image.

10. The electronic device of claim 9, wherein the screen image comprises a screen image currently displayed on each electronic device.

11. The electronic device of claim 9, wherein the screen image comprises one or more of a screen image in a standby mode, a home screen image, a wallpaper image, and a user-set image in each electronic device.

12. The electronic device of claim 9, wherein the controller receives a model image of each electronic device and displays the image.

13. The electronic device of claim 12, wherein the controller synthesizes the received model image with the received screen image of each electronic device and displays the synthesized image.

14. The electronic device of claim 9, wherein the controller receives information about each other electronic device and displays the received information, together with the received screen image of each other electronic device.

15. The electronic device of claim 14, wherein the information about each electronic device comprises one or more of a model name, device identification information, and a user name of the electronic device.

16. The electronic device of claim 9, wherein the controller resizes the received screen image and displays the resized screen image.

17. A computer-readable recording medium having recorded thereon a program of instructions configured to be readable by at least one processor for instructing the at least one processor to execute a computer process for performing the method as recited in claim 1.
